(19) United States
(12) Patent Application Publication
(10) Pub. No.: US 2014/0231636 A1
(43) Pub. Date: Aug. 21, 2014

(54) FIBER OPTIC ACOUSTIC SENSOR ARRAYS, FIBER OPTIC SENSING SYSTEMS AND METHODS OF FORMING AND OPERATING THE SAME

(71) Applicant: US Seismic Systems, Inc., Chatsworth, CA (US)

(72) Inventors: Eric Lee Goldner, Valencia, CA (US); Frederick C. DeMetz, Rancho Cucamonga, CA (US)

(73) Assignee: US Seismic Systems, Inc., Chatsworth, CA (US)

(21) Appl. No.: 14/184,111

(22) Filed: Feb. 19, 2014

Related U.S. Application Data
(60) Provisional application No. 61/766,919, filed on Feb. 20, 2013.

(51) Int. Cl. G01H 9/00; G01J 1/04

(52) U.S. Cl. CPC G01H 9/004; G01J 1/0425
USPC 250/227.11; 385/13; 29/825

(57) ABSTRACT

A fiber optic acoustic sensing array. The fiber optic acoustic sensing array includes a core strength member and an optical fiber wound on the core strength member. The optical fiber includes a plurality of Fiber Bragg Gratings, and is coated with a voided plastic coating. An outer jacket covers the optical fiber coated with the voided plastic coating. Also disclosed are fiber optic sensing systems, methods of forming a fiber optic acoustic sensing array, and methods of operating fiber optic sensing systems.

### RELATED APPLICATION

This application claims the benefit of priority to U.S. Provisional Patent Application Ser. No. 61/766,919, filed on Feb. 20, 2013, the contents of which are incorporated in this application by reference.

### TECHNICAL FIELD

The field of the invention relates to fiber optic sensing systems, and more particularly, to improved fiber optic acoustic sensing arrays for use in such fiber optic sensing systems.

### BACKGROUND OF THE INVENTION

It is sometimes desirable to detect the presence of swimmers or watercraft. For example, it may be desirable to detect swimmers using Self-Contained Underwater Breathing Apparatus (SCUBA) or Closed Circuit Rebreathers (CCRs), where the swimmers might be intent on attacking an installation, or intruding upon the land nearby the relevant body of water. Existing swimmer detection systems generally utilize active sonar systems. However, such sonar systems typically suffer from a number of drawbacks (e.g., such systems may be easily discovered and defeated, such systems may cause harm to marine mammals, etc.).

Fiber optic sensing systems are utilized in various applications such as, for example, seismic sensing. However, certain conventional fiber optic sensing systems suffer from deficiencies such as a lack of sensitivity in sensing certain conditions.

Thus, it would be desirable to provide improved fiber optic sensing systems which may be useful in swimmer detection, watercraft detection, as well as other applications.

### BRIEF SUMMARY OF THE INVENTION

To meet this and other needs, and according to an exemplary embodiment of the present invention, a fiber optic acoustic sensing array is provided. The fiber optic acoustic sensing array includes a core strength member and an optical fiber wound on the core strength member to create an extended, dynamic pressure sensor. The optical fiber includes a plurality of Fiber Bragg Gratings. The optical fiber is coated with a voided (gas-included) plastic coating. An outer jacket covers the optical fiber coated with the voided plastic coating (e.g., to protect it from abrasion and other damage mechanisms).

The voided plastic coating may be extruded onto the optical fiber. In one example, a plastic material (e.g., polyurethane) may be mixed with a foaming agent. As the foaming agent is heated, gas bubbles (e.g., air bubbles) are formed to define holes/voids in the plastic material. As the optical fiber is moved through the plastic material (e.g., a matrix of the plastic material defining holes/voids) a coating of the plastic material is applied to the optical fiber.

According to another exemplary embodiment of the present invention, a fiber optic sensing system is provided. The fiber optic sensing system includes an optical source, a lead cable for receiving optical signals from the optical source, and a fiber optic acoustic sensing array for receiving optical signals from the lead cable. The fiber optic acoustic sensing array includes (a) a core strength member; (b) an optical fiber, including a plurality of Fiber Bragg Gratings, wound on the core strength member, the optical fiber being coated with a voided plastic coating; and (c) an outer jacket covering the optical fiber coated with the voided plastic coating. The fiber optic sensing system also includes an interrogator for receiving optical signals from the fiber optic acoustic sensing array, and for further signal processing.

According to yet another exemplary embodiment of the present invention, a method of forming a fiber optic acoustic sensing array is provided. The method includes the steps of: (a) providing a core strength member; (b) writing a plurality of Fiber Bragg Gratings in an optical fiber; (c) providing a voided plastic coating on the optical fiber; (d) winding the optical fiber, with the voided plastic coating, on the core strength member; and (e) covering the optical fiber, coated with the voided plastic coating, with an outer jacket.

According to yet another exemplary embodiment of the present invention, a method of operating a fiber optic sensing system is provided. The method includes the steps of: (a) providing an optical signal using an optical source; (b) transmitting the optical signal from the optical source to a fiber optic acoustic sensing array, the fiber optic acoustic sensing array including (1) a core strength member and (2) an optical fiber having a plurality of Fiber Bragg Gratings and being both wound on the core strength member and coated with a voided plastic coating, and (3) an outer jacket covering the optical fiber coated with the voided plastic coating; and (c) receiving and processing optical signals from the fiber optic acoustic sensing array with an interrogator. Additional details regarding operation of a fiber optic sensing system are provided, for example, with respect to FIG. 1B.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a block diagram of a fiber optic sensing system in accordance with an exemplary embodiment of the present invention;

FIG. 1B is a block diagram of another fiber optic sensing system in accordance with another exemplary embodiment of the present invention;

FIG. 1C is a block diagram of a fiber optic acoustic sensing array in accordance with an exemplary embodiment of the present invention;

FIG. 1D is a block diagram of another fiber optic acoustic sensing array in accordance with another exemplary embodiment of the present invention;

FIG. 2A is a block diagram perspective view of a portion of a fiber optic acoustic sensing array in accordance with an exemplary embodiment of the present invention;

FIG. 2B is a block diagram perspective view of a portion of another fiber optic acoustic sensing array in accordance with another exemplary embodiment of the present invention;

FIG. 2C is a block diagram perspective view of a portion of another fiber optic acoustic sensing array in accordance with yet another exemplary embodiment of the present invention;

FIGS. 3A, 3B, 3C, 3D, 3E, 3F, and 3G are a series of block diagram views illustrating a method of forming a fiber optic acoustic sensing array in accordance with an exemplary embodiment of the present invention;

FIG. 4 is a block diagram perspective view of a portion of another fiber optic acoustic sensing array in accordance with yet another exemplary embodiment of the present invention;

FIG. 5 is a block diagram illustration of a fiber optic sensing system for sensing information related to at least one of a watercraft and a person in a body of water in accordance with an exemplary embodiment of the present invention;

FIG. 6 is a block diagram illustration of a fiber optic sensing system for sensing information related to vertical seismic profiling in accordance with an exemplary embodiment of the present invention;

FIG. 7 is a block diagram illustration of a fiber optic sensing system for sensing information related to tunnel detection in accordance with an exemplary embodiment of the present invention; and

FIG. 8 is a block diagram illustration of a fiber optic sensing system for sensing information related to at least one of a microseismic event and geothermal monitoring in accordance with an exemplary embodiment of the present invention.

### DETAILED DESCRIPTION OF THE INVENTION

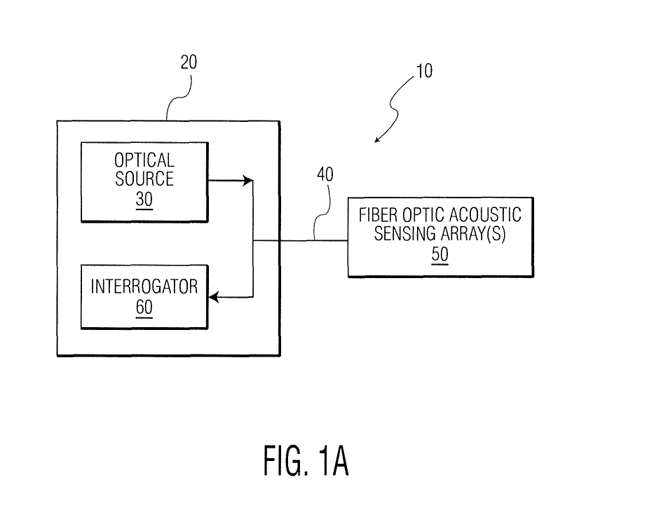

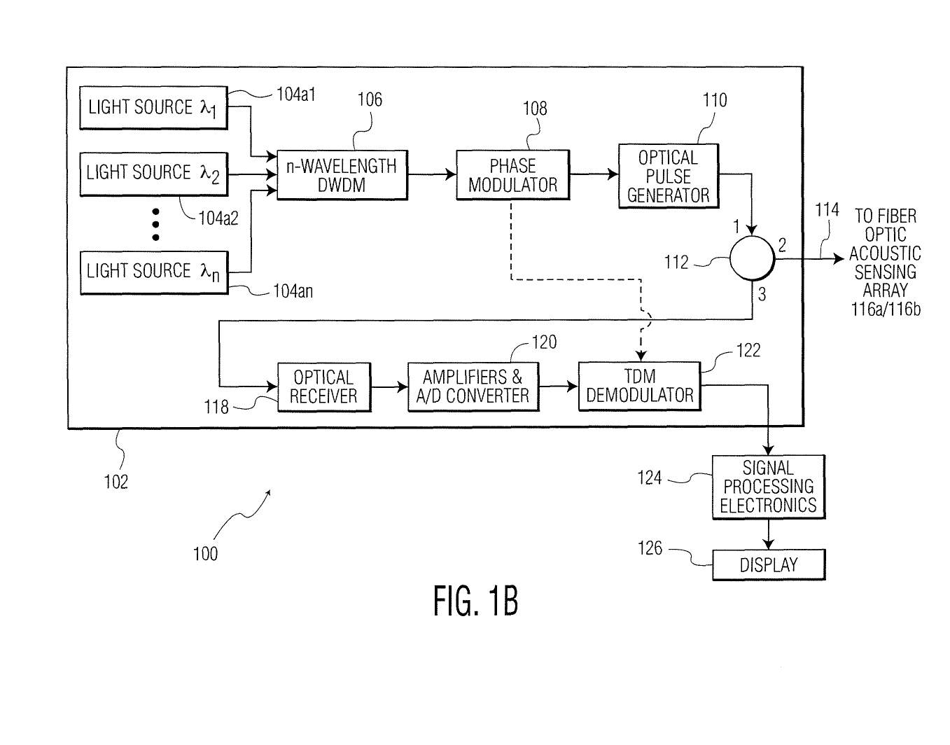

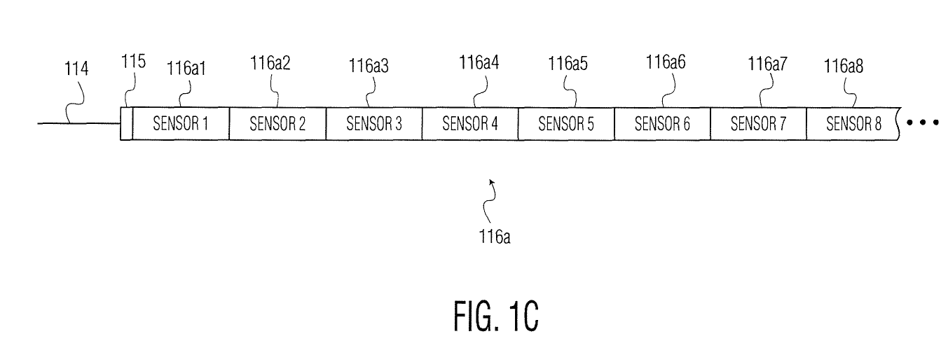

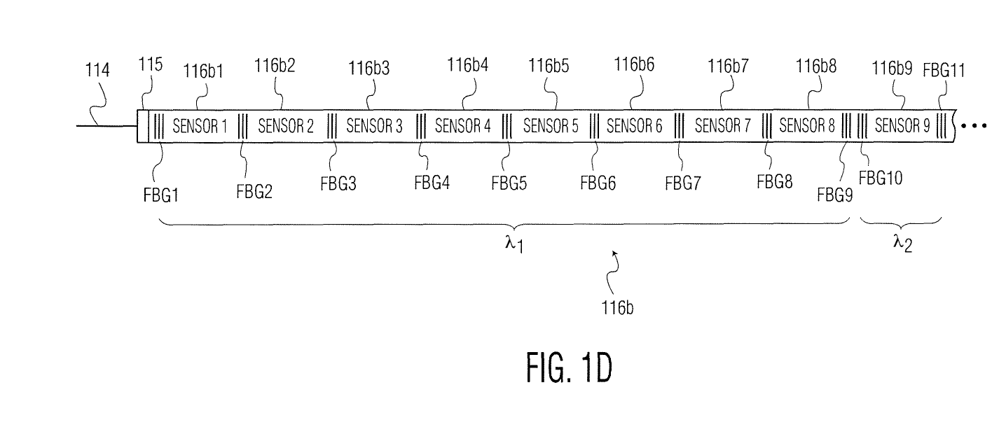

FIG. 1 illustrates an exemplary fiber optic sensing system 10. Fiber optic sensing system 10 includes an optics assembly 20. Optics assembly 20 includes optical source 30 (e.g., a modulated laser, etc.) and an interrogator 60. Of course, optics assembly 20 may include additional elements (e.g., opto-electronics elements) as desired in the given application, for example, to enable multiple wavelength operation. Optical signals are transmitted from optical source 30, along a lead cable 40, and to a fiber optic acoustic sensing array 50. Optical signals are returned from fiber optic acoustic sensing array 50, along lead cable 40, and are received by interrogator 60 for further processing. As will be appreciated by those skilled in the art, optics assembly 20 and fiber optic acoustic sensing array 50 may vary considerably within the scope of the present invention. FIG. 1B illustrates an exemplary optics assembly 102 (which is an example of optics assembly 20), and FIGS. 1C-1D illustrate exemplary fiber optic acoustic sensing arrays 116a, 116b (which are examples of fiber optic acoustic sensing array 50).

Referring now specifically to FIG. 1B, a fiber optic sensing system 100 includes the optics assembly 102. Optics assembly 102 includes a plurality of light sources 104a1, 104a2, . . . , 104an (e.g., lasers) for generating multi-wavelength light at wavelengths λ₁, λ₂, . . . , kn. For example, the light generated by light sources 104a1, 104a2, . . . , 104an may be long coherence, narrow linewidth light. The multi-wavelength light from light sources 104a1, 104a2, . . . , 104an is multiplexed (i.e., using wavelength multiplexing) using, for example, an n-wavelength Dense Wavelength Division Multiplexer (i.e., DWDM) 106 (or some other wavelength combining element, such as cascaded Optical Add/Drop Multiplexers, OADM). A phase frequency carrier, generated by a phase modulator 108, is applied to the multiplexed output of DWDM 106, thereby modulating the phase of the multi-wavelength light from DWDM 106. The light is then pulsed using an optical pulse generator 110 (using such devices as cascaded acousto-optical modulators, optical switches, Semiconductor Optical Amplifiers (SOAs), etc.), the output of which passes through an optical circulator 112 (whose allowable transmission states are from port 1 to port 2, and from port 2 to port 3). Therefore, optical signals (e.g., a series of phase-modulated, multi-wavelength light pulses) are transmitted to a fiber optic acoustic sensor array (see exemplary arrays 116a, 116b detailed in FIGS. 1C-1D) along a lead cable 114 for interrogation.

Optical signals are returned from the sensors of fiber optic acoustic sensor array 116a, 116b, where the optical signals are intensity pulses that incorporate phase information mixed with the pre-generated phase carrier from phase modulator 108. The optical signals (light) pass through optical circulator 112 (via port 2 to port 3) to an optical receiver 118. Optical receiver 118 converts the optical signals (light) to electrical signals. The electrical signals are amplified, filtered and converted to a digital signal within an amplifier and A/D converter module 120. The digitized signal is downconverted using a TDM demodulator 122 into a digital word representing an instantaneous pressure change at each of the sensors (i.e., the sensors in fiber optic acoustic sensor array 116a, 116b) for further signal processing at signal processing electronics 124. The specific signal processing depends upon the final application of fiber optic sensing system 100. For example, signal processing electronics 124 may beamform signals from the sensors, may stack events (e.g., in the case of vertical seismic profiling), may filter and retransmit information to other systems (e.g., for data recording, C²I, data fusion with other sensors such as temperature or pressure sensors, magnetometers, imaging SONAR, display, etc.) for further observation, noise reduction, classification, false/nuisance alarm mitigation, and event mapping, among other functions. In the example shown in FIG. 1B, the output of signal processing electronics 124 is transmitted to a display 126.

FIG. 1C illustrates exemplary fiber optic acoustic sensing array 116a. As indicated in FIG. 1B, optical signals are transmitted from optics assembly 102, along lead cable 114, to fiber optic acoustic sensing array 116a. Array 116a is connected to lead cable 114 using a termination module 115 that provides a mechanical connection between lead cable 114 and array 116a. Termination module 115 may also serve as a location for multiplexing optics used to connect multiple arrays of sensors at a common location. Fiber optic acoustic sensing array 116a includes eight acoustic sensors 116a1, 116a2, 116a3, 116a4, 116a5, 116a6, 116a7, and 116a8 (additional sensors may be included downstream of sensor 116a8 as shown in FIG. 1C). In this example, the sensors are arranged linearly (end-to-end). Each sensor includes a length of at least one optical fiber and may extend a desired length (e.g., a length as short as about 2.5 centimeters, or as long as many meters) as dictated by a number of system-level considerations, such as sensed region coverage, array gain, beamforming spectrum, spatial and angular resolution, etc.

FIG. 1D illustrates another exemplary fiber optic acoustic sensing array 116b defined by a TDM (i.e., time division multiplexing) optical architecture. As indicated in FIG. 1B, optical signals are transmitted from optics assembly 102, along lead cable 114, to fiber optic acoustic sensing array 116b. Array 116b is connected to lead cable 114 using a termination module 115. The illustrated TDM optical architecture is created by a linear series of Fabry-Perot interferometers (where such interferometers are illustrated as sensors 116b1, 116b2, 116b3, 116b4, 116b5, 116b6, 116b7, 116b8, 116b9, etc.). Each sensor (interferometer) is physically and optically bounded by a pair of FBGs (Fiber Bragg gratings) written into an optical fiber included in array 116b, where each grating may act as an interferometric reflector. For example, sensor 116b1 is bounded by FBG1 and FBG2, sensor 116b2 is bounded by FBG2 and FBG3, and so on (i.e., sensors may share gratings of a common wavelength if desired, such as sensors 116b1 and 116b2 sharing FBG2). An exemplary spacing of the FBGs is on the order of 10-100 meters apart, as measured along the optical fiber. In the example shown in FIG. 1D, a series of eight sensors is shown operating at one wavelength (λ₁), and one sensor 116b9 is shown operating at a second wavelength (λ₂) where the additional sensor (or sensors not shown in FIG. 1D) operating at this second wavelength are downstream of sensor 116b8. Note that FBG9 and FBG10 are of two different wavelengths. That is, FBG9 shares a common wavelength with FBG1 through FBG8, and FBG10 shares a common wavelength with a plurality of downstream sensors and FBGs beginning with FBG 11. As will be appreciated by those skilled in the art, FBG9 and FBG10 may be located only a few inches apart along an optical fiber included in array 116b.

In FIG. 1D, the sensing in each sensor is accomplished within a coated optical fiber included in array 116b. The coated optical fiber acts as a dynamic pressure sensor due to its strain dependence upon pressure which results in changes in the phase of light propagating through the optical fiber. The coating (e.g., a voided plastic coating described herein) enhances the natural strain versus pressure sensitivity of the optical fiber as much as two orders of magnitude, or more, depending upon a number of parameters such as the elastic modulus of the coating, the compressibility of the coating (governed, in part, by the density of the voids), the diameter of the glass within the optical fiber, and the outer diameter of the voided coating. Voiding or foaming of the plastic/polymer to create a plastic/gas matrix may be achieved, for example, by inclusion of a foaming substance or hollow microspheres into the liquid or softened plastic/polymer prior to application to the fiber (e.g., through extrusion). It may also be achieved by adding specially manufactured gas-filled microspheres to thermoplastic pellets prior to injection into a crossfed extruder. An example of such microspheres is marketed under the trade name Expancel by the AkzoNobel Company. When optically configured as an interferometer, each sensor returns an optical intensity to the interrogation electronics in optics assembly 102 (see FIG. 1B) where the optical intensity contains modulated information which is proportional to an instantaneous change in pressure (vibration).

As detailed below, prior to the application of a voided polymer coating to the optical fiber, FBGs are written into the optical fiber. An exemplary peak reflectivity of an FBG is on the order of 1-10%, and the 3 dB linewidth is on the order of 1-4 micrometers. Through the use of Time Division Multiplexing (TDM), many sensors may be included along a single optical fiber. Array 116b may be interrogated through the use of long coherence length optical pulses, where the wavelength of each pulse is within the reflectivity spectrum of the FBGs. The temporal length of such a pulse, for example, may be equal to twice the length of time required for the light to traverse along the optical fiber from one FBG to the next.

As will be appreciated by those skilled in the art, increasing the number of sensors in array 116b may be accomplished by use of multiple wavelengths of the interrogation pulse light. Each FBG reflects one wavelength of light, with all other wavelengths transmitted with very little loss. Therefore, array 116b is arranged such that a first set of sensors (i.e., sensors 116b1 through 116b8) operates at a common wavelength (λ₁), and another set of sensors (i.e., beginning with sensor 116b9) operates at another common wavelength (λ₂), where λ₂ is different from λ₁. Of course, additional wavelengths (e.g., λ₃-λₙ) may be utilized. Such a wavelength division multiplexing (WDM) architecture may be combined with a TDM architecture for an increased number of sensors within array 116b.

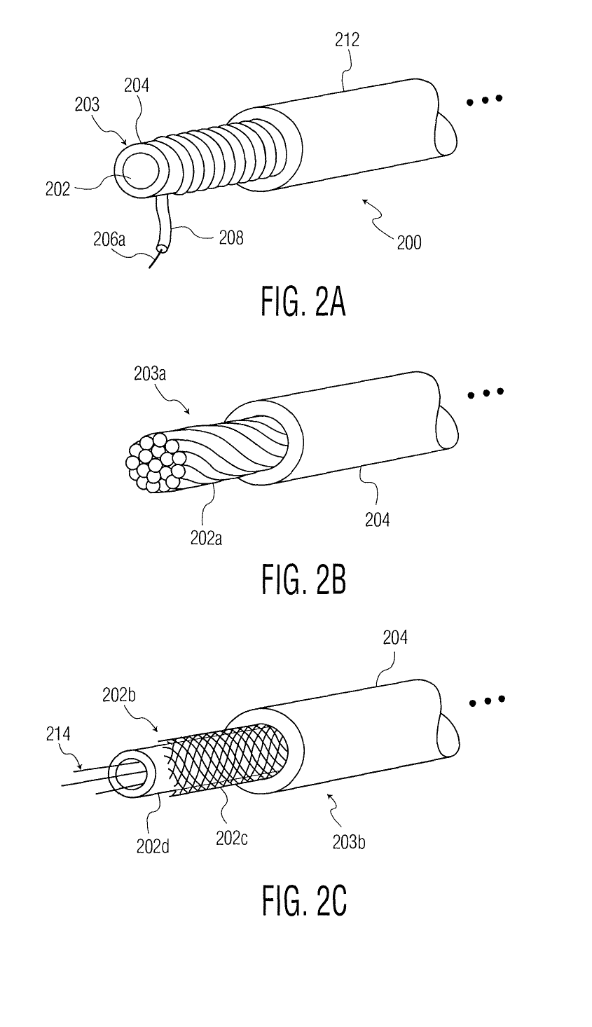

FIG. 2A illustrates a portion of an exemplary fiber optic acoustic sensing array 200. Array 200 includes a core strength member 203 including an inner strength member 202 (e.g., a metal rope such as a steel rope; a synthetic rope such as an aromatic polyester, liquid crystal polymer or a para-aramid synthetic fiber—with exemplary synthetic materials including those sold under such trade names as Kevlar, Vectran, Spectra, etc.) and an outer jacket 204 (e.g., a soft buffer layer). Exemplary materials used to form outer jacket 204 include plastics, elastomers and rubber—with more specific exemplary materials including polyurethane, polyvinylchloride, perfluoroalkoxy alkane, and polyethylene. An optical fiber 206a, coated with a voided plastic coating 208, is wound (e.g., in a helix configuration) around core strength member 203. An outer jacket 212 covers fiber 206a (coated with voided plastic coating 208), where outer jacket 212 may be a plastic jacket molded, wrapped or extruded over fiber 206a.

Many variations from that shown in FIG. 2A are contemplated within the scope of the present invention. For example, core strength member 203 may take a number of configurations. FIGS. 2B and 2C illustrate two exemplary core strength members 203a, 203b. Referring specifically to FIG. 2B, core strength member 203a includes a steel rope inner strength member 202a covered by outer jacket 204. Referring specifically to FIG. 2C, core strength member 203b includes an inner strength member 202b covered by outer jacket 204. Inner strength member 202b includes a tubular structure 202d (defining a tubular aperture) covered by a synthetic braided strength member 202c (wherein member 202c includes a plurality of strands in a mesh configuration provided around structure 202d). In the example shown in FIG. 2C, additional (pass-through) optical fibers 214 are housed within tubular structure 202d (where tubular structure 202d is formed from a material such as metal, plastic, etc.).

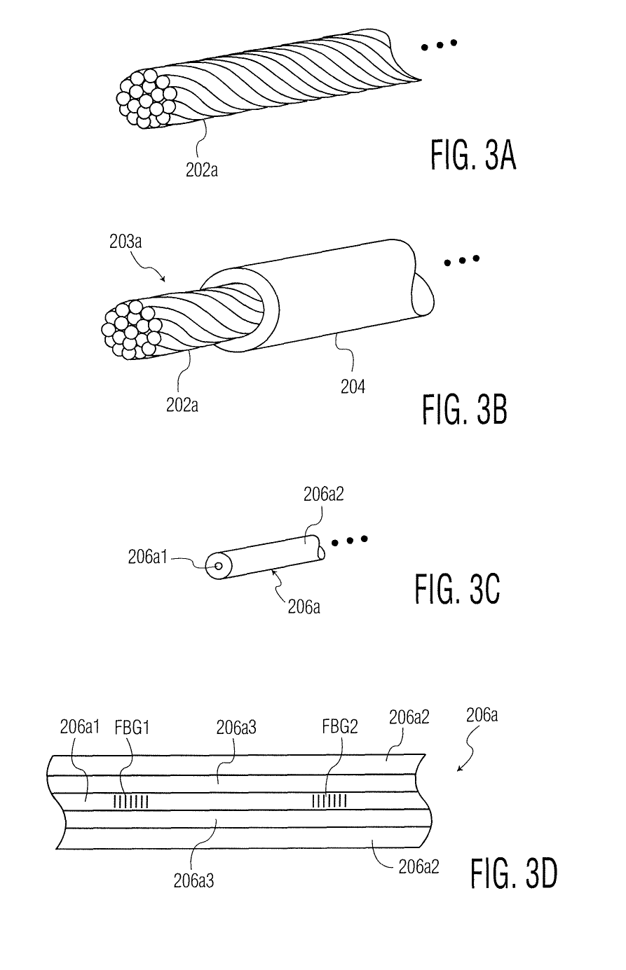

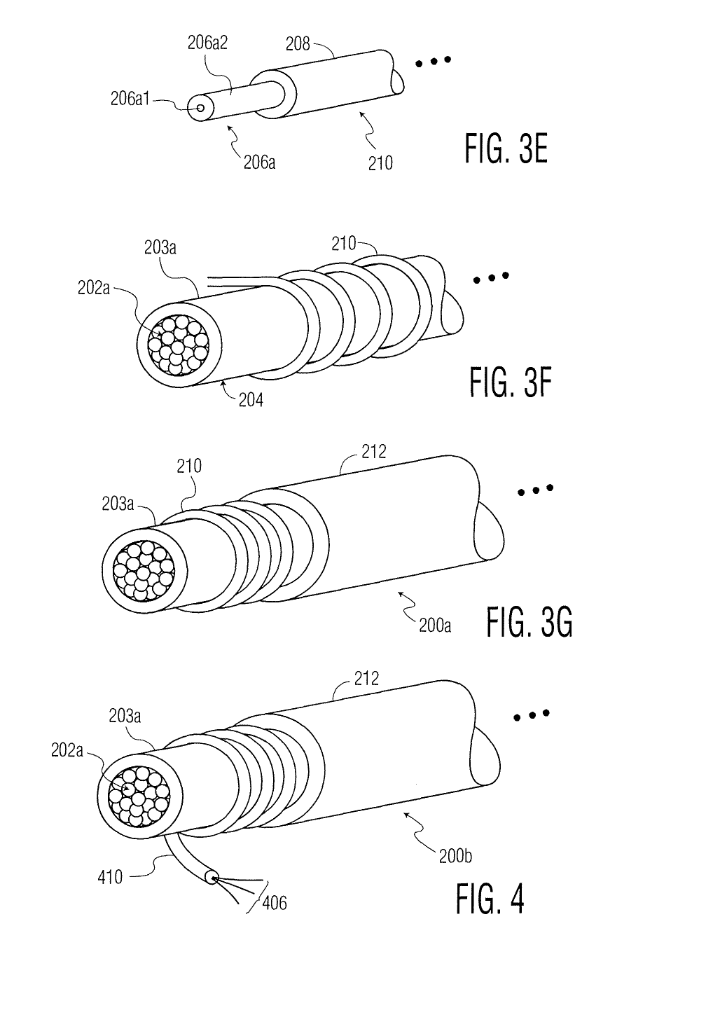

FIGS. 3A through 3G illustrate a method of forming a fiber optic acoustic sensing array 200a (where array 200a is a more specific example of array 200 shown in FIG. 2A). FIG. 3A illustrates steel rope inner strength member 202a. In FIG. 3B, outer jacket 204 (e.g., formed of a material such as plastic, elastomer, or rubber) has been extruded or molded over inner strength member 202a to form core strength member 203a. An exemplary core strength member 203a is flexible, has an outside diameter within a range of about 0.5 to 5 centimeters, and has an exemplary bend radius in a range of about 20 to 75 centimeters.

FIG. 3C illustrates optical fiber 206a which includes an optical fiber core 206a1 (e.g., having a silica cladding diameter in a range of 80-200 micrometers) and a buffer layer 206a2 (shown in FIG. 3D) having a diameter in a range of 150-300 micrometers. FIG. 3D is a side sectional (internal) view of optical fiber 206a, and illustrates FBGs (e.g., FBG1, FBG2) written into core 206a1 of optical fiber 206a. Such FBGs may be written into core 206a1 using, for example, a laser and an interferometer that, together, are used to locally change the morphology of the glass creating a periodic pattern of regions of different refractive indexes along core 206a1 to modify its reflection and transmission spectra. Each such FBG pattern typically occupies a distance along the glass of core 206a1 on the order of 0.1 to 10 centimeters.

A glass cladding 206a3 surrounds core 206a1 of optical fiber 206a. Around glass cladding 206a3 is the buffer layer 206a2, which may be extruded plastic. Layer 206a2 may be made of an acrylate or polyimide material, and layer 206a2 has an exemplary outer diameter ranging from 110-300 microns. FIG. 3E illustrates the voided plastic coating 208 having been extruded over optical fiber 206a, thereby forming a coated optical fiber 210. An exemplary material used for extrusion of voided plastic coating 208 is a plastic voided through foaming. As used herein, the term “plastic” refers to a broad class of materials including polymeric materials, rubber materials, elastomeric materials, etc., with specific example materials being polyurethane, PVC, and silicone. Voided plastic coating 208 enhances the acoustic sensitivity (strain per unit pressure change) of optical fiber 206a. An exemplary thickness of voided plastic coating 208 is within a range of about 0.5-10 millimeters.

FIG. 3F illustrates coated optical fiber 210 having been wound (e.g., helically wound) on core strength member 203a. FIG. 3G illustrates outer jacket 212 (e.g., a plastic jacket formed of, for example, polyurethane, polyethylene, PVC, FEP, PFA, polypropylene, etc.) extruded over wound coated optical fiber 210, thereby forming fiber optic acoustic sensing array 200a. Outer jacket 212 protects coated optical fiber 210 from damage due to such mechanisms as abrasion, compression and severe bending and helps to provide a desirable acoustic window (e.g., the acoustic impedance is desirably close to that of a surrounding medium such as water or oil). If desired, one or more intermediate layers (e.g., formed of a depolymerized rubber, a tape such as cotton, etc.) may be interposed between coated optical fiber 210 and outer jacket 212, for example, to provide a more uniform diameter along the length of fiber optic acoustic sensing array 200a.

It is noteworthy that the actual fiber winding technique used to form an array 200/200a may vary as desired in a given application; for example, in FIG. 2A optical fiber 206a (including coating 208) is wound relatively tightly in forming array 200, while in FIG. 3G coated optical fiber 210 is wound with a greater spacing between each turn during formation of array 200a. In some applications, such greater spacing may be provided to allow space for an additional fiber or fibers, or plastic filler rods of materials such as nylon or Teflon (for radial mechanical support), to be wound on the respective core strength member.

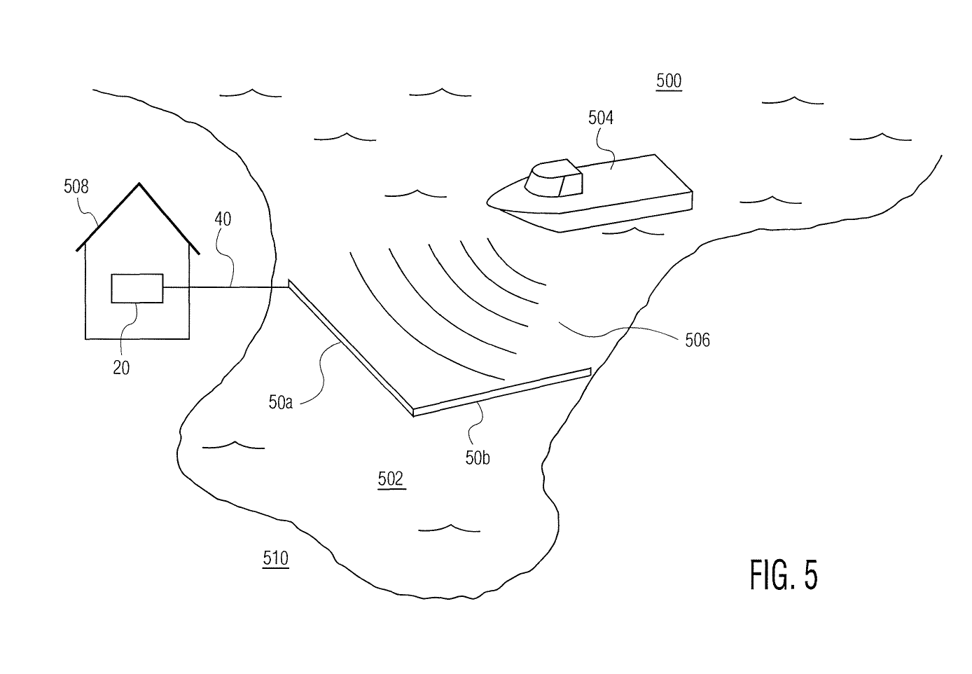

Of course, many variations from the exemplary fiber optic acoustic sensing arrays shown in FIGS. 2A-2C and 3A-3G are contemplated within the scope of the present invention. For example, FIG. 4 illustrates another exemplary fiber optic acoustic sensing array 200b including core strength member 203a (previously described) wound with a coated fiber cable 410 (including a plurality of optical fibers 406). Optical fibers 406 may be individually coated (e.g., with a voided plastic coating extruded as described above) or may coated as a group.

In another exemplary array configuration (not shown), one or more uncoated optical fibers may be wound on a core strength member, and then a voided plastic coating may be applied (e.g., through extrusion) to the core strength member wound with the uncoated optical fiber(s).

The fiber optic acoustic sensing arrays, and corresponding fiber optic sensing systems, disclosed herein have wide applicability and may be used in many different applications where fiber optic sensing may be utilized, for example, watercraft detection (e.g., surface watercraft, submarines, etc.), swimmer detection (e.g., SCUBA, CCRs), microseismic detection, leak detection (e.g., fluid leak, gas leak, etc.), vertical seismic profiling, tunnel detection, geothermal recovery, perimeter security, airport security, oil rig protection, trail rail monitoring, surface seismic monitoring (both for earthquakes and monitoring of seismic events associated with human activities), nuclear power plant protection, seismic streamer systems, towed hydrophone arrays, among others. FIGS. 5-8 illustrate exemplary applications of the inventive fiber optic acoustic sensing arrays, and corresponding fiber optic sensing systems.

FIG. 5 relates to a marine detection system. A body of water 500 includes a harbor 502. A watercraft 504 (or a swimmer, not shown) emits acoustic vibrations 506. Optics assembly 20 (e.g., including an optical source, interrogation electronics, etc.) is housed within structure 508 on land 510. A lead cable 40 connects optics assembly 20 to fiber optic acoustic sensing arrays 50a, 50b. Arrays 50a, 50b are linear acoustic arrays arranged at an angle with respect to each other (e.g., such that during beamforming, directional and/or positional redundancies may be reduced), and across the entrance to harbor 502. The illustrated angle arrangement may be referred to as a “V” pattern. Shown in a serial configuration, arrays 50a, 50b may also be configured in a parallel configuration. As will be appreciated by those skilled in the art, a different number of fiber optic acoustic sensing arrays (e.g., a single array, more than two arrays, etc.) may be provided. Arrays 50a, 50b may be disposed, for example, on or below the floor of harbor 502. Arrays 50a, 50b sense acoustic vibrations 506. Arrays 50a, 50b may be configured as a tripline, or via beamforming, to locate and/or track a watercraft or a swimmer. To enable the system to determine the depth at which a target exists or is moving, one or more fiber optic sensing arrays may be arranged vertically (e.g., extending from an anchoring structure to a buoyant structure located vertically above the anchoring structure).

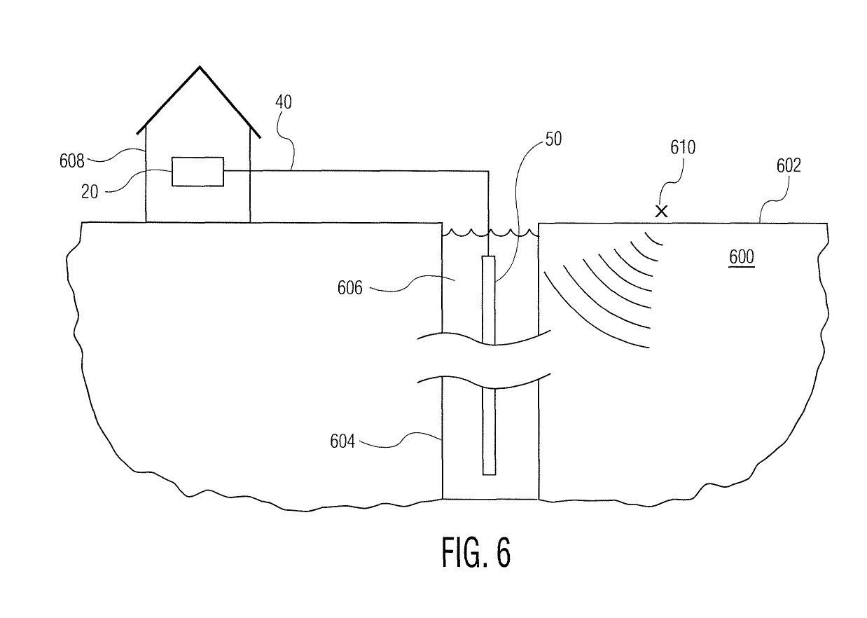

FIG. 6 relates to vertical seismic profiling (e.g., for sensing vibrations travelling through the earth 600 to map subsurface structures). Optics assembly 20 (e.g., including an optical source, interrogation electronics, etc.) is housed within a structure 608 located above a ground surface 602. A lead cable 40 connects optics assembly 20 to fiber optic acoustic sensing array 50. Array 50 may be disposed either directly within earth 600, or as shown, in a well 604 (e.g., a well filled with a fluid 606, a cement-filled well, etc.) provided in earth 600 below ground surface 602. A source of vibration 610 (e.g., a vibration truck, an accelerated weight drop machine, an air gun, an explosive charge, a downhole sparker, etc.) emits acoustic vibrations sensed by array 50. Such acoustic vibrations may be sensed directly, or indirectly, by array 50. For example, indirectly sensed acoustic vibrations may be sensed after reflecting and/or refracting in relation to various subsurface structures and compositions (e.g., sand, oil, methane, different rock types, etc.).

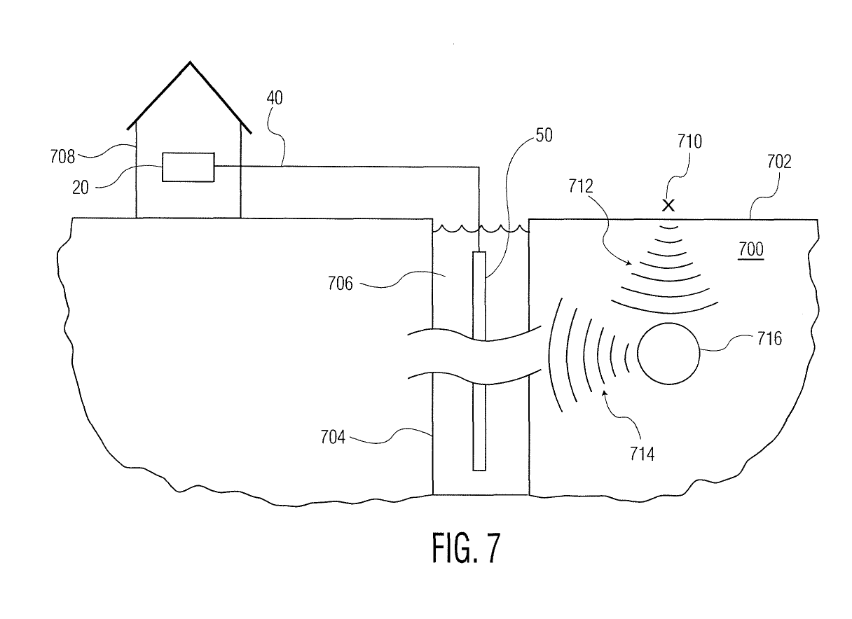

FIG. 7 relates to tunnel detection (e.g., for sensing acoustic vibrations which may be compared to known temporal and spectral patterns to detect the presence of a tunnel). Optics assembly 20 (e.g., including an optical source, interrogation electronics, etc.) is housed within a structure 708 above a ground surface 702. A lead cable 40 connects optics assembly 20 to fiber optic acoustic sensing array 50. Array 50 may be disposed either directly within earth 700, or as shown, in a well 704 (e.g., a well filled with a fluid 706, a cement-filled well, etc.) provided in earth 700 below ground surface 702. A source of vibration 710 emits acoustic vibrations 712 that may be received directly by array 50. Acoustic vibrations 712 may also be reflected and/or refracted by a tunnel 716, creating acoustic vibration patterns 714 sensed by array 50 which differ in reflected or refracted direction and propagation speed depending upon the material through which the vibrations pass.

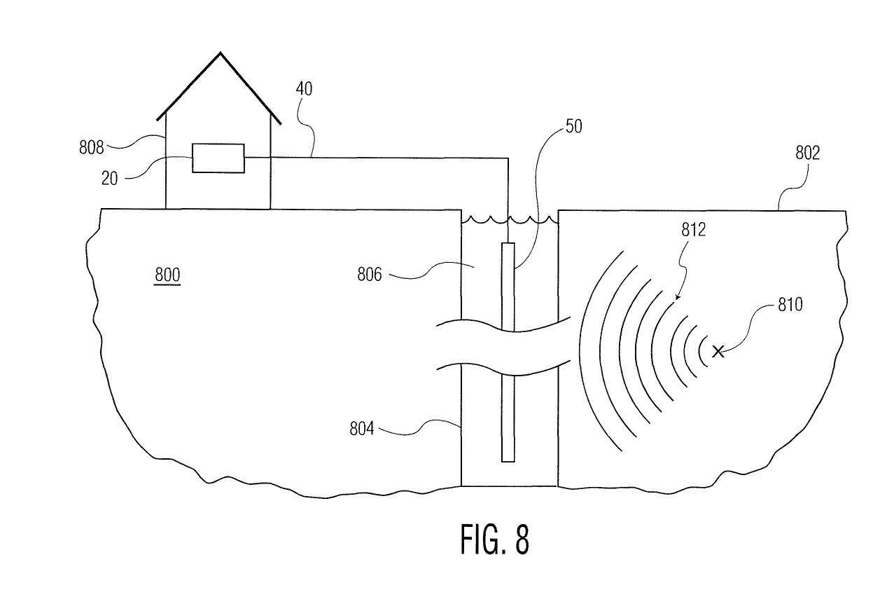

FIG. 8 relates to microseismic detection (e.g., for sensing a microseismic event, such as acoustic events during, and caused by, hydrofracturing) and/or enhanced geothermal recovery (e.g., for sensing seismic events and other acoustic events during production of geothermal energy). Optics assembly 20 (e.g., including an optical source, interrogation electronics, etc.) is housed within a structure 808 above a ground surface 802. A lead cable 40 connects optics assembly 20 to fiber optic acoustic sensing array 50. Array 50 is disposed in a well 804 (e.g., a fluid filled well filled with a fluid 806, a cement-filled well, etc.) provided in earth 800 below ground surface 802. An event 810 (e.g., a seismic or microseismic event) emits acoustic vibration 812 sensed by array 50 for the purpose of mapping the location, extent and propagation of subsurface motion, or for mapping fluid movement in earth 800 and within, for example, oil, gas and geothermal production wells (not shown).

As will be appreciated by those skilled in the art, fiber optic acoustic sensing arrays according to the present invention may include additional active sensor components. For example, each array may include one or more accelerometers. The accelerometers may include a transducer as part of a sensing leg, where the transducer includes (a) a fixed portion configured to be secured to a body of interest, (b) a moveable portion having a range of motion with respect to the fixed portion, (c) a spring positioned between the fixed portion and the moveable portion, and (d) a length of fiber wound between the fixed portion and the moveable portion, the length of fiber spanning the spring. Further, each of the fixed portion, the moveable portion, and the spring may be formed from a unitary piece of material. Examples of such transducers and accelerometers are disclosed in PCT International Publication Number WO/2011/050227 entitled “FIBER OPTIC TRANSDUCERS, FIBER OPTIC ACCELEROMETERS, AND FIBER OPTIC SENSING SYSTEMS,” the content of which is incorporated by reference in its entirety.

In accordance with various aspects of the present invention recited herein, a number of benefits may be achieved. For example, a highly producible construction for fiber optic acoustic sensing arrays is provided consistent with low cost manufacturing in a cable factory. Further, continuous, passive, fiber optic acoustic sensors may be provided. Both a TDM and a WDM architecture may be utilized to maximize the number of sensors in the fiber optic acoustic sensing array(s), and to optimize their performance by grouping sensors (e.g., 4-16 sensors, each defined by respective FBGs) of a common wavelength in contiguous sub-arrays (e.g., where each sub-array includes such a group of sensors at a common wavelength). Benefits that may be achieved related to FBGs include: a peak reflectivity of each FBG that increases from the proximal grating to the distal grating in each set of common wavelength gratings; and low peak reflectivity gratings (e.g., 1-20%) to minimize crosstalk between sensors. Signal processing benefits include simultaneous: (a) beam forming of low frequency signals (e.g., on the order of approximately 10-10,000 Hz); (b) infrasonic detection of very low frequency signals (e.g., on the order of approximately 0.2-0.4 Hz, such as human breathing); and (c) omnidirectional sensing of high frequency signals (e.g., on the order of approximately 40-80 kHz). Another feature is the undersampling of high frequency signals to alias them to lower frequency ranges more easily processed by the interrogation electronics whose bandwidth may be limited to much lower detection and processing frequencies.

Although illustrated and described above with reference to certain specific embodiments, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges. It is also expressly intended that the steps of the methods of using the various devices disclosed above are not restricted to any particular order.

What is claimed:

1. A fiber optic acoustic sensing array comprising:
a core strength member;
an optical fiber, including a plurality of Fiber Bragg Gratings, being wound on the core strength member, the optical fiber being coated with a voided plastic coating; and
an outer jacket covering the optical fiber coated with the voided plastic coating.

2. The fiber optic acoustic sensing array of claim 1 wherein the voided plastic coating includes polyurethane.

3. The fiber optic acoustic sensing array of claim 1 wherein a thickness of the voided plastic coating is in a range between 0.5-10 mm.

4. The fiber optic acoustic sensing array of claim 1 wherein the core strength member is flexible.

5. The fiber optic acoustic sensing array of claim 1 wherein the core strength member has a bend radius in a range of 20 to 75 centimeters.

6. The fiber optic acoustic sensing array of claim 1 wherein the core strength member includes an inner strength member and an outer jacket, the optical fiber coated with the voided plastic coating being wound on the outer jacket.

7. The fiber optic acoustic sensing array of claim 6 wherein the outer jacket includes a material selected from the group consisting of polyurethane, polyvinylchloride, perfluoroalkoxy alkane, and polyethylene.

8. The fiber optic acoustic sensing array of claim 1 wherein the core strength member has a diameter in a range of 0.5 to 5 centimeters.

9. The fiber optic acoustic sensing array of claim 1 wherein the optical fiber is coated with the voided plastic coating before being wound on the core strength member.

10. The fiber optic acoustic sensing array of claim 1 including a plurality of the optical fibers, each of the plurality of optical fibers being coated with the voided plastic coating, and each of the plurality of optical fibers coated with the voided plastic coating being wound on the core strength member.

11. The fiber optic acoustic sensing array of claim 1 wherein the optical fiber is included in a multi-fiber optical cable, the multi-fiber optical cable being coated with the voided plastic coating, and the multi-fiber optical cable being wound on the core strength member.

12. The fiber optic acoustic sensing array of claim 1 wherein the core strength member is tubular.

13. The fiber optic acoustic sensing array of claim 12 wherein the tubular core strength member is formed from a material selected from the group consisting of plastic and metal.

14. A fiber optic sensing system comprising:
a optical source;
a lead cable for receiving optical signals from the optical source;
a fiber optic acoustic sensing array for receiving optical signals from the lead cable, the fiber optic acoustic sensing array including (a) a core strength member, (b) an optical fiber having a plurality of Fiber Bragg Gratings and being both wound on the core strength member and coated with a voided plastic coating, and (c) an outer jacket covering the optical fiber coated with the voided plastic coating; and
an interrogator receiving optical signals from the fiber optic acoustic sensing array, and for further signal processing.

15. The fiber optic sensing system of claim 14 wherein the voided plastic coating includes polyurethane.

16. The fiber optic sensing system of claim 14 wherein a thickness of the voided plastic coating is in a range between 0.5-10 mm.

17. The fiber optic sensing system of claim 14 wherein the core strength member is flexible.

18. The fiber optic sensing system of claim 14 wherein the core strength member has a bend radius in a range of 20 to 75 centimeters.

19. The fiber optic sensing system of claim 14 wherein the core strength member includes an inner strength member and an outer jacket, the optical fiber coated with the voided plastic coating being wound on the outer jacket.

20. The fiber optic sensing system of claim 19 wherein the outer jacket includes a material selected from the group consisting of polyurethane, polyvinylchloride, perfluoroalkoxy alkane, and polyethylene.

21. The fiber optic sensing system of claim 14 wherein the core strength member has a diameter in a range of 0.5 to 5 centimeters.

22. The fiber optic sensing system of claim 14 wherein the optical fiber is coated with the voided plastic coating before being wound on the core strength member.

23. The fiber optic sensing system of claim 14 including a plurality of the optical fibers, each of the plurality of optical fibers being coated with the voided plastic coating, and each of the plurality of optical fibers coated with the voided plastic coating being wound on the core strength member.

24. The fiber optic sensing system of claim 14 wherein the optical fiber is included in a multi-fiber optical cable, the multi-fiber optical cable being coated with the voided plastic coating, and the multi-fiber optical cable being wound on the core strength member.

25. The fiber optic sensing system of claim 14 wherein the core strength member is tubular.

26. The fiber optic sensing system of claim 25 wherein the tubular core strength member is formed from a material selected from the group consisting of plastic and metal.

27. The fiber optic sensing system of claim 14 wherein the fiber optic sensing system senses information related to at least one of a watercraft and a person in a body of water, the fiber optic sensing array being positioned within or beneath the body of water.

28. The fiber optic sensing system of claim 14 wherein the fiber optic sensing system senses information related to vertical seismic profiling, the fiber optic acoustic sensing array being positioned in a well.

29. The fiber optic sensing system of claim 14 wherein the fiber optic sensing system senses information related to tunnel detection, the fiber optic acoustic sensing array being positioned below the surface of the earth.

30. The fiber optic sensing system of claim 14 wherein the fiber optic sensing system senses information related to microseismic events, the fiber optic acoustic sensing array being positioned in a well.

31. The fiber optic sensing system of claim 14 wherein the fiber optic sensing system senses information related to geothermal monitoring, the fiber optic acoustic sensing array being positioned in a well.

32. The fiber optic sensing system of claim 14 further comprising a plurality of fiber optic accelerometers along the fiber optic acoustic sensing array.

33. The fiber optic sensing system of claim 32 wherein each of the plurality of fiber optic accelerometers includes a fixed portion and a moveable portion, wherein a portion of the optical fiber is wrapped around the fixed portion and the moveable portion.

34. The fiber optic sensing system of claim 14, wherein the optical source is a modulated optical source, and wherein the interrogator converts optical signals received from the fiber optic acoustic sensing array into electrical signals, and demodulates the converted electrical signals.

35. A method of forming a fiber optic acoustic sensing array, the method comprising the steps of:
(a) providing a core strength member;
(b) writing a plurality of Fiber Bragg Gratings on an optical fiber;
(c) providing a voided plastic coating on the optical fiber;
(d) winding the optical fiber, with the voided plastic coating, on the core strength member; and
(e) covering with an outer jacket the optical fiber coated with the voided plastic coating.

36. The method of claim 35 further comprising the step of coating the core strength member in a jacket before the step of winding the optical fiber on the core strength member.

37. The method of claim 36 wherein the step of coating the core strength member includes coating the core strength member with a material selected from the group consisting of polyurethane, polyvinylchloride, perfluoroalkoxy alkane, and polyethylene.

38. The method of claim 35 wherein the step of providing the core strength member includes winding a plurality of strands together to provide the core strength member.

39. The method of claim 35 wherein the step of providing the core strength member includes winding a plurality of strands around a tubular structure to provide the core strength member.

40. The method of claim 35 further comprising the step of connecting the fiber optic acoustic array to an optical source and an interrogator using a lead cable.

41. The method of claim 40 further comprising the step of transmitting optical signals from the optical source to the lead cable and to the fiber optic acoustic sensing array.

42. The method of claim 41 further comprising the steps of transmitting optical signals from the fiber optic acoustic sensing array to the interrogator, converting optical signals received from the fiber optic acoustic sensing array into electrical signals at the interrogator, and demodulating the converted electrical signals at the interrogator for further signal processing.

43. A method of operating a fiber optic sensing system, the method comprising the steps of:
(a) providing an optical signal using an optical source;
(b) transmitting the optical signal from the optical source to a fiber optic acoustic sensing array, the fiber optic acoustic sensing array including (1) a core strength member and (2) an optical fiber having a plurality of Fiber Bragg Gratings and being both wound on the core strength member and coated with a voided plastic coating, and (3) an outer jacket covering the optical fiber coated with the voided plastic coating; and
(c) receiving and processing optical signals from the fiber optic acoustic sensing array with an interrogator.
